(19) United States
(12) Patent Application Publication
(10) Pub. No.: US 2006/0157310 A1
(43) Pub. Date: Jul. 20, 2006

(54) Active vibration damper for an automobile

(75) Inventors: Chong-Won Lee, Daejeon (KR); Bo Ha Lee, Jeonju-si (KR)

Correspondence Address: EDWARDS & ANGELL, LLP, P.O. BOX 55874, BOSTON, MA, 02205, US

(73) Assignee: Hyundai Motor Company, Seoul (KR)

(21) Appl. No.: 11/305,171

(22) Filed: Dec. 15, 2005

(30) Foreign Application Priority Data
Dec. 21, 2004 (KR) 10-2004-0109104

(51) Int. Cl. F16F 15/03

(52) U.S. Cl. 188/267; 188/164; 267/140.15

(57) ABSTRACT

An oscillating force generator of an active vibration damper is provided that comprises in preferred aspects a housing in communication with a target object for which vibrations are to be reduced; an electromagnet; one or more permanent magnets; and inertial mass that can induce an inertial force. Preferred systems of the invention can generate a counter-oscillating force with relatively reduced power (current) input.

### CROSS REFERENCE TO RELATED APPLICATION

This application is based on, and claims priority to Korean Patent Application No. 10-2004-0109104, filed on Dec. 21, 2004, the disclosure of which is hereby incorporated by reference.

### TECHNICAL FIELD OF THE INVENTION

The present invention relates to an active vibration damper, which is suitably adapted for an automobile. More particularly, the active vibration damper generates an oscillating force utilizing an electromagnetic force to control or offset the vibration generated from a motor vehicle component.

### BACKGROUND OF THE INVENTION

A passive vibration damper optimally tuned to a specific frequency and a semi-active vibration damper capable of adjusting an inertial mass or stiffness have been employed to reduce vibrations generated from automobile components. However, such conventional vibration dampers are not able to effectively reduce vibrations resulting from a complex signal that contains several frequencies.

To address such problems with passive devices, as shown in the accompanying FIG. 5, an active vibration damper has been recently developed and employs an actuator that generates an oscillating force by means of facing electromagnets. Such active vibration damper is composed of a target object to be damped, which vibrates with an oscillating force (Ft), an oscillating force generator 100 that generates a counter-oscillating force (Fc) in response to a control signal to thereby reduce or offset the oscillating force (Ft), and a controller generating the control signal to be provided with the oscillating force generator 100. The oscillating force generator 100 includes an electromagnetic system and is directly mounted on the target object for which vibrations are to be reduced.

Specifically, the oscillating force generator 100 includes a housing 110 firmly attached to a component of a vehicle, for which vibrations are to be dampened, electromagnets 120 consisting of yoke members and coils surrounding the yoke members, and an inertial mass 130 reciprocating via electromagnetic force within the housing 110 for inducing an inertial force. Preferably, the housing 110 may be provided with a guide member for restraining the inertial mass 130 from moving in the lateral direction. More preferably, the oscillating force generator 100 may comprise a displacement sensor for detecting the movement of the inertial mass 130.

In designing an active vibration damper using the above-described oscillating force generator 100, we have now identified several factors worthy of consideration.

First, the oscillating force generator 100 should be sufficiently small so as to be readily installed to a component of a vehicle, for which vibrations are to be dampened, such as an internal combustion engine.

Second, the electrical efficiency of the oscillating force generator 100 has been quite low due to energy loss caused by an eddy current and a hysteresis is inevitable while generating an oscillating force by means of electromagnets 120 of the oscillating force generator 100.

Third, considering the principle of the active vibration damper, in which a counter-oscillating force is utilized having an opposed phase of a frequency with respect to the frequency of the vibration to be dampened, the magnitude of the counter-oscillating force should be sufficiently large to offset the oscillating force generated by the component of a vehicle.

Fourth, when a vibration is generated by an internal combustion engine, which vibration will inherently include a high frequency, the oscillating force generator 100 should generate a counter-oscillating force having substantially the same frequency with the vibration in order to effectively offset the vibration.

Fifth, a power source supplied to the active vibration damper should be limited to a DC 12V because such a direct current is often the only available power source in a conventional vehicle.

However, the conventional active vibration damper has not fully satisfied the requirements as described above, including that conventional device have poor electrical efficiency and therefore require significant current to obtain a desired counter-oscillating force.

The information set forth in this Background of the Invention section is only for enhancement of understanding of the invention and should not be taken as an acknowledgement or any form of suggestion that this information forms the prior art that is already known to a person skilled in the art.

### SUMMARY OF THE INVENTION

In one aspect, an active vibration damper for a vehicle is provided. Preferred active vibration dampers are capable of maximizing a counter-oscillating force generated therefrom under the current constraint in response to a vibration to be dampened, in which various ranges of frequencies are included, whereby electrical efficiency can be improved.

In one specifically preferred embodiment, an active vibration damper is provided with an oscillating force generator comprising a housing, which is in communication with to a target object for which vibrations are to be dampened. Suitably, the active vibration damper is in communication including such as by direct attachment whereby counter-oscillating force generated by the vibration damper is effectively transferred to the target object. Within the housing, an electromagnet is suitably disposed and preferably comprises a core and coils preferably wound at opposed ends of the core. The current necessary to generate an effective counter-oscillating force can be reduced via a combination of two magnetic fluxes from the both ends of the electromagnet. A permanent magnet is suitably positioned midway from both ends of the electromagnet, between the coils.

The oscillating force generator further preferably includes inertial masses that reciprocate suitably in a vertical direction within the housing in conjunction with the movement of the permanent magnet while inducing an inertial force. In addition, guide members are preferably furnished in the housing so as to prevent or least minimize lateral movement while facilitating vertical movement of the inertial mass. The guide members are preferably located at both lateral sides of the inertial mass to ensure linear motion of the inertial mass in the vertical direction.

Preferably, the oscillating force generator is provided with a Hall sensor that can measure a displacement of the inertial masses through use of a Hall Effect within magnetic fluxes of the electromagnet and the permanent magnet.

Further provided are vehicle components and systems such as a vehicle engine and a vehicle transmission that are in effective communication with one or more of the described active vibration damper. As referred to herein, active vibration damper will be in “effective communication” with an engine, transmission or other object targeted for vibration reduction where the active vibration damper device can transmit counter-oscillating force to the object and vibrations are thereby reduced. Direct physical contact of the active vibration damper and the object targeted for vibration reduction are often preferred, although many other configurations will be suitable, including where an interposing structure is positioned between the vibration damper and the object targeted for vibration reduction.

Also provided are vehicles such as an automobile that comprise one or more of the described active vibration dampers.

It is understood that the term “vehicle” or “vehicular” or other similar terms as used herein is inclusive of motor vehicles in general such as passenger automobiles, buses, trucks, various commercial vehicles, watercraft including a variety of boats, aircraft, and the like.

Other aspects of the invention are discussed below.

### BRIEF DESCRIPTION OF THE DRAWINGS

The aforementioned aspects and other features of the present invention will be explained in the following detailed description, taken in conjunction with the accompanying drawings, wherein:

FIGS. 1a and 1b are perspective views of an oscillating force generator according to an embodiment of the present invention;

FIG. 2 is a sectional view of an oscillating force generator according to an embodiment of the present invention;

FIG. 3 is a sectional view of an oscillating force generator according to an embodiment of the present invention, in which magnetic fluxes induced by an electromagnet and permanent magnets are schematically illustrated;

FIG. 4 is a side-sectional view of an oscillating force generator according to an embodiment of the present invention, in which an inertial mass is omitted so that a hall senor is specifically depicted; and

FIG. 5 is a sectional view of a conventional oscillating force generator.

### DETAILED DESCRIPTION OF THE INVENTION

As discussed above, active vibration damper devices are provided that comprise an oscillating force generator. Preferred oscillating force generators of damper devices of the invention may include in combination one or more electromagnets, one or more permanent magnets and one or more inertial masses that can induce an inertial force.

Without being bound by any theory, it is believed that comparatively reduced power (current) requirements for preferred devices of the invention may result at least in part from the magnetic flux of the one or more electromagnets being able to superpose with the magnetic flux of the one or more permanent magnets. As is understood, electromagnets may rely upon electric current to generate a magnetic field whereas permanent magnets need not rely on such outside influences to generate their field. Preferably components of an active vibration damper device of the invention are configured and arranged to be capable of providing such reduced power (current) requirements.

The oscillating force generator also may preferably include a housing unit which houses the or more electromagnets, one or more permanent magnets and one or more inertial masses. In use, the housing preferably is in effective communication with object targeted for vibration reduction such as an engine or transmission of a vehicle. The oscillating force generator also preferably comprises one or more guide members which may be present within the housing unit and can facilitate desired movement of the one or more inertial masses. For example, one or more guide members may be provided within a system housing for preventing lateral movement of the inertial mass while facilitating the vertical movement of the inertial masses. In such configurations, the guide members may be suitably located at both lateral sides of the inertial mass.

In preferred systems, an active vibration damper system for a vehicle according to the present invention suitably comprises a target object for which vibrations are to be reduced, which is a component of a vehicle and generates an oscillating force (Ft). The oscillating force generator can generate a counter-oscillating force (Fc) in response e.g. to specific control signals in order to offset the oscillating force (Ft) from the target object. The system may include a control unit (e.g. computer control) for providing the oscillating force generator with the control signal based on which the magnitude of the counter-oscillating force (Fc) is generated and preferably modified as desired. The component of a vehicle generating vibration is often e.g. an engine or a transmission.

Preferred control units may include a feed-forward controller configured to supply a control signal which urges the oscillating force generator to generate a counter-oscillating force having the substantially same magnitude as the oscillating force from the target object while having a opposed phase thereto. The control unit preferably further comprises a feedback controller that is adapted for eliminating external vibrations other than the oscillating force and the counter-oscillating force.

According to a preferred embodiment of the present invention, the oscillating force generator is equipped with an electromagnetic system to generate an appropriate counter-oscillating force in response a control signal from the control unit.

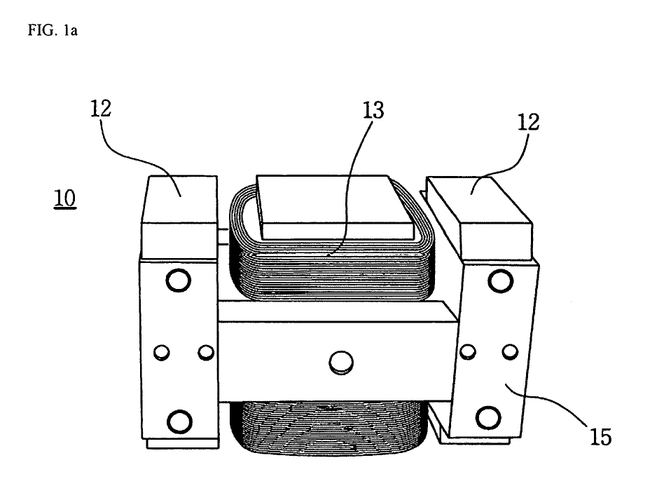

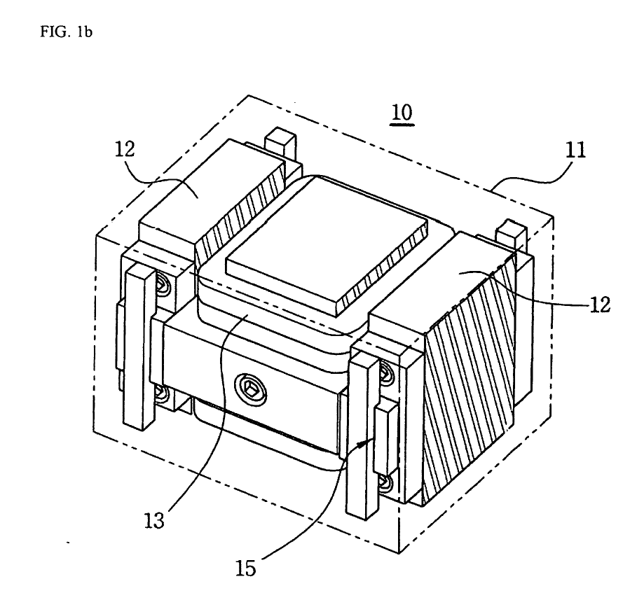

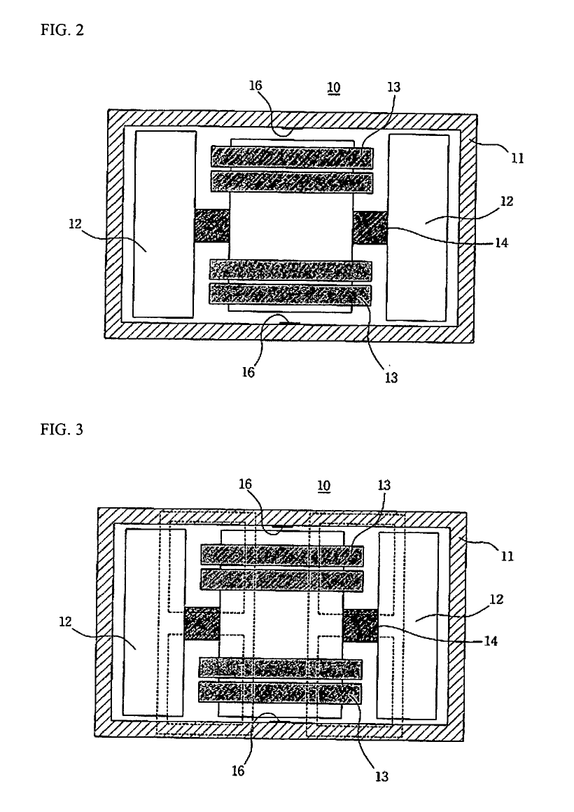

Referring to FIGS. 1b and 2, a particularly preferred oscillating force generator 10 comprises a housing 11, inertial masses 12, an electromagnet 13 suitably forming magnetic fluxes at opposed ends thereof, one or more permanent magnets 14, and preferably one or more guide members 15 and one or more apparatus displacements sensors which suitably are Hall sensors 16.

As shown in FIGS. 1a and 1b, the preferred depicted housing 11 has a box structure, which is suitable for readily attaching the system to a target object through conventional fastening means, such as a bracket and a fastener, whereby the counter-oscillating force generated from the oscillating force generator is directly transferred to the target object via the housing 11.

The depicted preferred electromagnet 13 suitably includes a core, at opposed ends of which coils are wound. The permanent magnets 14 are preferred arranged approximately midway from both ends of the core, between the coils.

Magnetic fluxes formed by the electromagnet 13 and the permanent magnets 14 are virtually illustrated in FIG. 3. With reference to FIG. 3, the magnetic flux of the electromagnet 13 is superposed with the magnetic fluxes of the permanent magnets 14 at a portion where the inertial masses 12 and an internal surface of the housing 11 face each other, thereby reducing a required current to drive the inertial masses 12. Accordingly, such a configuration can improve electrical (power) efficiency of the system. The inertial masses 12 preferably can induce an inertial force while reciprocating in the vertical direction via the magnetic forces of the electromagnet 13 and the permanent magnets 14, which have different magnetic directions.

Referring to FIG. 1b, the depicted preferred guide members 15 are suitably attached to both lateral sides of the inertial masses 12 to prevent undesired lateral movement of the inertial masses 12 within the housing 11 while ensuring a linear motion of the inertial masses in the vertical direction. The preferred depicted guide member 15 comprises a rail member and a corresponding groove member for slideably accommodating the rail member therein. Other configurations and designs of guide members also will be suitable.

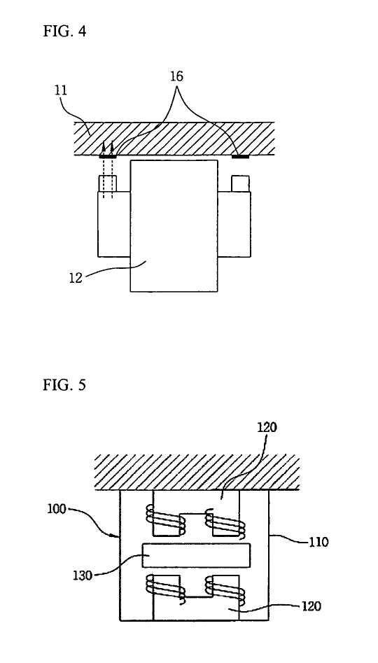

In a preferred embodiment according the present invention, the oscillating force generator 10 further comprises one or more Hall sensors 16 for measuring the displacement of the inertial masses 12. As shown in FIG. 4, the Hall sensors 16 are firmly installed to the inner surface of the housing 11, which measure a relative displacement between moving parts and the housing. For an active vibration damper system, the measurement of the displacement can be important to actively control vibration reduction. While other displacement sensors also may be suitably employed, use of Hall sensors maybe preferred, including for economic production of the system.

Accordingly, the hall sensors 16 can serve to stabilize the oscillating force generator 10 by measuring the displacement of the inertial masses 12 without contact of the masses using a Hall Effect within magnetic fluxes of the electromagnet 13 and the permanent magnets 14.

In preferred systems of the invention, the amount of a current supplied to the electromagnet 13 of the oscillating force generator 10 can be varied in accordance with control signals inputted from the external controller. Subsequently, the density of magnetic flux within the housing 11 also can be modified while reciprocating the inertial masses 12. Such a reciprocating movement of the inertial masses 12 induces a vibrating motion of the whole oscillating force generator, which is ultimately transferred to a target objected for which vibrations are to be reduced.

While the invention has been described with reference to specific embodiments, modifications and variations may be constructed without departing from the scope of the invention, which is defined in the following claims.

What is claimed is:

1. An oscillating force generator of an active vibration damper, the oscillating force generator comprising:
a housing attached to a target object for which vibrations are to be reduced, via which the counter-oscillating force generated from the oscillating force generator is directly transferred to the target object;
an electromagnet comprising a core and coils wound at opposed ends of the core, by which the necessary current to generate a counter-oscillating force can be reduced via a combination of two magnetic fluxes from the both ends of the electromagnet;
permanent magnets positioned midway from the both ends of the electromagnet, between the coils;
inertial mass reciprocating in a vertical direction within the housing in conjunction with the movement of the permanent magnets while inducing an inertial force; and
guide members provided within the housing for preventing a lateral movement of the inertial masses while facilitating the vertical movement of the inertial masses, the guide members being located at both lateral sides of the inertial mass.

2. The oscillating force generator of an active vibration damper according to claim 1, further comprising a hall sensor that can measure a displacement of the inertial masses in a non-contact manner using a Hall Effect within magnetic fluxes of the electromagnet and the permanent magnet.

3. The oscillating force generator of claim 1 wherein the target object is an engine or transmission.

4. The oscillating force generator of claim 1 further comprising a Hall sensor.

5. An oscillating force generator of an active vibration damper, the oscillating force generator comprising:
a housing in communication with a target object for which vibrations are to be reduced;
one or more electromagnets;
one or more permanent magnets;
inertial mass that can induce an inertial force; and
guide members provided within the housing for facilitating desired movement of the inertial mass.

6. The oscillating force generator of claim 5 wherein the counter-oscillating force generated from the oscillating force generator is directly transferred to a target object.

7. The oscillating force generator of claim 5 wherein the electromagnet comprises a core and coils wound at opposed ends of the core.

8. The oscillating force generator of claim 7 wherein current to generate a counter-oscillating force can be reduced via a combination of two magnetic fluxes from the both ends of the electromagnet.

9. The oscillating force generator of claim 5 wherein the one or more permanent magnets are positioned approximately midway from the both ends of the electromagnet.

10. The oscillating force generator of clam 5 further comprising a Hall sensor.

11. The oscillating force generator of claim 5 wherein the target object is an engine or transmission.

12. An oscillating force generator of an active vibration damper, the oscillating force generator comprising:
one or more electromagnets;
one or more permanent magnets; and
inertial mass that can induce an inertial force.

13. The oscillating force generator of claim 12 wherein the electromagnet comprises a core and coils wound at opposed ends of the core.

14. The oscillating force generator of claim 12 wherein current to generate a counter-oscillating force can be reduced via a combination of two magnetic fluxes.

15. The oscillating force generator of claim 12 wherein during use of the generator magnetic flux of the one or more electromagnets can be superposed with the magnetic flux of the one or more permanent magnets.

16. The oscillating force generator of claim 12 further comprising a component for measuring displacement of the inertial mass.

17. The oscillating force generator of clam 12 further comprising a Hall sensor.

18. A motor vehicle comprising an oscillating force generator of claim 1.

19. A motor vehicle comprising an oscillating force generator of claim 5.

20. A motor vehicle comprising an oscillating force generator of claim 12.
